(19) United States
(12) Patent Application Publication
(10) Pub. No.: US 2009/0084452 A1
(43) Pub. Date: Apr. 2, 2009

(54) COEZE

(76) Inventor: RAY BROYLES, Springfield, MO (US)

Correspondence Address: RAY BROYLES, 2365 S. MCCANN, SPRINGFIELD, MO, 65804, US

(21) Appl. No.: 11/904,275

(22) Filed: Sep. 27, 2007

(51) Int. Cl. F16K 31/00

(52) U.S. Cl. 137/624.27

(57) ABSTRACT

The device—COEZE—prevents the overflowing of the toilet stool contents upon the floor of the bathroom when the toilet is flushed-usually caused by an obstruction or cloggage of the main house sewer line.

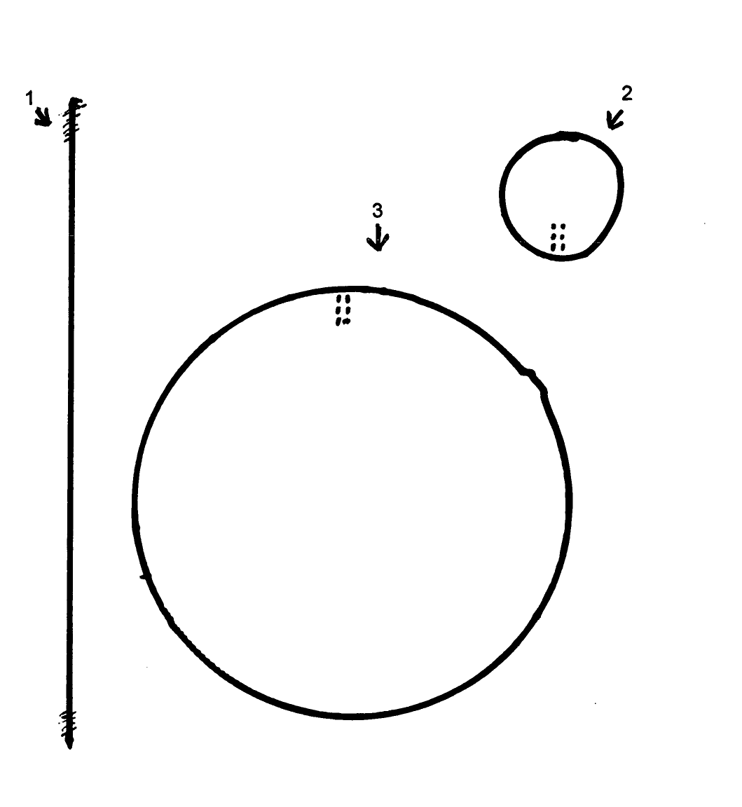

When a cloggage occurs, fluid and pressure build up in the sewer line. This causes the float ball (inside the vertical cleanout pipe} to rise and in turn the finial (resting on the top cap) to also rise. This exposes the ¾ inch hole in the top cap allowing the pressure and fluids to be released outside the home rather than inside.

No federal sponsorship

No corporate sponsorship

### FIELD—PLUMBING

Device prevents pressure buildup and backup of fluids through the home sewer lines into a home when a blockage of the main home sewer line occurs.

### DESCRIPTION

The device consists of three items—
One—A ⅛ by 12 inch brass rod-both ends of which are threaded.
Two—A one inch diameter brass ball with one set of imbedded threads (a finial).
Three—A four inch diameter brass ball with one set of imbedded threads (a toilet tank float ball)

### Construction {See Drawings)

A finial is threaded onto one end of a 12 inch by ⅛ brass rod. A toilet tank float ball is threaded onto the other end of the brass rod.

### Usage

In the event of a cloggage of the house sewer line, the device expels pressure and fluids outside the home rather than inside the home.

### EXPLANATION OF DRAWINGS

1—One is a twelve inch by one/eighth inch brass rod threaded on both ends. Drawing of one is half size (six inches) in length.

2—Two is a one inch diameter brass ball with one set of female threads.

It is a finial and is screwed onto one end of rod 1 and sits on a ¾ inch circular hole in the top cap of the PVC cleanout pipe (above ground). The drawing of 2 is actual size.

3—Three is a four inch diameter toilet tank float ball. This ball fits perfectly in the PVC cleanout pipe and moves easily within it. The ball is screwed onto the other end of the rod 1 and sits in the PVC cleanout pipe below ground level. Three is actual size.

1. COEZE consists of a four inch diameter tank ball and a one inch diameter brass ball (finial) connected by a ⅛ by 12 inch brass rod. The rod has threads on both ends which are screwed into the female threads in the toilet tank ball(bottom) and the threads in the one inch finial (top). The rod is placed thru a three-quarter inch hole in the cleanout outlet cap of the home sewer line with the one inch finial on top of the cap and above ground and the toilet tank ball in the pvc outlet pipe sub-surface. If a cloggage occurs in the home sewer pipe the pressure and back-up of fluids in the main sewer pipe lift the tank ball which results in the one inch finial being lifted above the ¾ in hole in the cleanout outlet cap and allows the pressure and fluids in the system to be expelled thru the hole in the cap to the ground outside the home rather than overflowing the toilet bown with possible resulting spillage upon the flow of the home.
